(19) United States
(12) Patent Application Publication
(10) Pub. No.: US 2024/0138609 A1
(43) Pub. Date: May 2, 2024

(54) BLACKOUT AND SEMI-PERMEABLE, CELLULAR WOVEN CURTAIN FABRIC AND CURTAIN PRODUCTION METHOD

(71) Applicant: BERTEKS TEKSTIL SANAYI VE TICARET ANONIM SIRKETI, Bursa (TR)

(72) Inventors: Burcu ERDEBIL, Bursa (TR); Osman Murat ERDEBIL, Bursa (TR)

(21) Appl. No.: 18/051,706

(22) Filed: Nov. 1, 2022

(51) Int. Cl. A47H 23/08; A47H 13/14

(52) U.S. Cl. CPC A47H 23/08; A47H 13/14

(57) ABSTRACT

A production method of a blackout and semi-permeable, cellular curtain fabric used by connecting on all kinds of fixed, movable or folding windows, doors, glass balconies. The production method of the curtain fabric is also disclosed.

### CROSS-REFERENCE TO RELATED APPLICATIONS

Not applicable.

### BACKGROUND OF THE INVENTION

### 1. Field of the Invention

The invention relates to a curtain fabric, which is used by connecting on all kinds of fixed, movable or folding windows, doors, slide glass balconies.

In particular, the invention relates to a blackout and semi-permeable celled curtain fabric and its production method, whose fabric structure can reach the consumer in a wide range of products, thanks to the increase in the number of adjacent honeycomb cells that are produced at low cost by using the multi-layered fabric weaving technique.

### 2. Description of Related Art Including Information Disclosed Under 37 CFR 1.97 and 37 CFR 1.98

Since buildings are the longest-lasting and significantly energy-consuming structures in the economy sector and cover a wide range of products and services, they are considered as a priority work area in policies and programs for increasing energy efficiency and climate change. It is stated that heat losses experienced in buildings are caused by external walls (40%), windows (30%), doors (17%), roof (7%) and floors (6%). Similarly, 50% of the unwanted heat increase that occurs in the summer inside the houses is also caused by windows.

Honeycomb curtain systems are widely used in the current art for the creation of moving honeycomb-like insulated surfaces used in front of the window. Honeycomb curtain systems are basically based on the principle that two pleat fabrics are mutually matched and attached to each other directly with the help of an adhesive or indirectly via using a separate strip piece that has an adhesive feature. One of the pleat fabrics constitutes half of the honeycomb structure and the other pleat fabric constitutes the remaining half of the honeycomb. In the model where two pleat fabrics are glued via an adhesive strip, various strip preferences can be made depending on the situation. For example, while this strip layer may be of the same quality as the pleat fabric, it can be used in thicker and opaque strips depending on the situation. At the same time, this strip layer ensures that the peaks of the pleated fabrics coincide with each other.

In current applications, two fabrics are needed to create the honeycomb structure. The fabrics are first provided with the hardness required for the pleating process and then they are taken to the pleating process. After the desired pleat height is adjusted in both fabrics, either the adhesive is applied directly with the help of a machine or the fabrics are connected to each other using an adhesive strip. For this purpose, bonding applications and pleat crushing machine are needed in the creation of honeycomb cell in honeycomb curtain systems. In addition, in such a system, there is the cost of weaving the two fabrics, the cost of dyeing, the cost of crushing the pleat and the cost of the adhesive used to provide binding. Also, the adhesive used to connect the opposing pleat fabrics in honeycomb curtain formation has various disadvantages. Due to the use of adhesives, both the production cost increases and the adhesion feature is lost over time due to the temperature formed on the curtain, and the honeycomb structure created for air storage may deteriorate. When the creasing process is started in the pleat creasing machine, there is a risk of formation of dents and crests between the pleats depending on the width-length stability of the fabric.

In the literature survey, the document numbered EP0222534 was found as an example of the current art. The said invention relates to an expandable honeycomb structure production method with band joined folded material. According to the method of forming the honeycomb structure of the present invention, continuously feeding a continuous length of foldable material longitudinally of said length, its opposite longitudinal edges are folded over one side of the material. This folded material is then aligned with a second material in the form of a strip which is fed into overlying relationship with one side of the folded material. These aligned materials are then folded and wound in a continuous loop to form adjacent stacked layers of strip material. This layers are connected the strip material to the facing surface of the next layer of material. In the said invention, adhesive is used as a binder for keeping the strip materials together.

As a result, the existence of the above problems and the inadequacy of existing solutions necessitated an improvement in the relevant technical field.

### BRIEF SUMMARY OF THE INVENTION

The present invention relates to blackout and semi-permeable, cellular, curtain fabric and curtain production method, which eliminates the disadvantages mentioned above and brings new advantages to the related technical field.

The main purpose of the invention is to reveal the blackout and semi-permeable, cellular, curtain fabric produced by the multi-layer fabric weaving technique.

The purpose of the invention is to reveal the fabric structure, blackout and semi-permeable, celled curtain fabric that can reach the consumer in a wide range of products by increase the number of honeycomb cells standing side by side.

Another purpose of the invention is to produce a blackout and semi-permeable, cellular, curtain fabric produced at low cost by eliminating the use of adhesives.

Another purpose of the invention is to reveal a blackout and semi-permeable, cellular, curtain fabric in which to control the desired pile height with the number of weft yarns, unlike the honeycomb curtain system, by adjusting the desired pleat height in the pleating machine, and after the desired pleat height is given, a suitable thread is used in between in order to create the form of the pleat breaking process, which allows this thread to form the peak of the pleats and to contribute to the preservation of the structure's form when temperature is applied.

Another purpose of the invention is to reveal a blackout and semi-permeable, cellular, curtain fabric in which carrier guide threads are placed at certain intervals in order to facilitate the pleat breaking process, thanks to the multi-layered fabric weaving technique.

Another purpose of the invention is to reveal a blackout and semi-permeable, cellular, curtain fabric that guarantees a homogeneous pleat height by using the yarns and carrier guide threads to be used and the crushing process is carried out in a suitable machine.

Another purpose of the invention is to reveal a blackout semi-permeable, cellular, curtain fabric which reduces the production cost and creates air storage thanks to the absence of any adhesive in its structure and that does not deform over time due to the shape of the structure, UV and humidity.

In order to fulfill all the purposes stated above and which may arise from the detailed explanation, the invention is a blackout and semi-permeable, cellular curtain fabric used by connecting on all kinds of fixed, movable or folding windows, doors, glass balconies, the fabric comprising:
the upper fabric structure, which forms the floating half of the fabric structure created for air storage,
the bottom fabric structure, which forms the other floating half of the fabric structure created for air storage,
the carrier guide thread path created at regular intervals on the upper fabric structure and the bottom fabric structure,
the carrier guide thread, which is passed through the carrier guide thread path, enabling the fabric to be collected more easily in the special box in the pleating process,
the connection zone, which forms the intersection point of the upper fabric structure and the bottom fabric structure and forms the cells where the air will be stored within the upper fabric structure and the bottom fabric structure,
the pleated crushing point, which forms the apex of the appropriate thread for the crushing process to take place in order to provide the honeycomb form to the cells where the air will be stored in the connection zones.

In addition, the invention is a production method of a blackout and semi-permeable, cellular curtain fabric used by connecting on all kinds of fixed, movable or folding windows, doors, glass balconies, wherein; comprising the process steps of
feeding the curtain fabric in the form of a fabric ball ready for pleating process, which is produced by using multi-layered woven fabric production technique and turned into semi-finished products, horizontally into the special box in the fabric crushing machine where breaking process will be applied, and initiating the breaking process by coming to the pleat fabric compression zone in the special box,
when the amount of fabric to be shipped is reached, separating the curtain fabric from the fabric ball ready for breaking and preventing the dispersion of the curtain fabric by supporting the compression process with the press system,
pulling the carrier guide threads through the fabric structure by means of the rope pulling system in the fabric crushing machine,
fully compressing the partially compressed and pleated fabric with the press system by means of a pushing system,
placing the special box in the fixing oven and processing it at the appropriate temperature and time to increase the permanence of the pleat in the pleated fabric,
preparing the curtain fabric, the heat treatment of which has been completed, from the special box and ready for packaging.

The structural and characteristic features and all advantages of the invention outlined in the drawings below and in the detailed description made by referring these figures will be understood clearly. Therefore, the evaluation should be made considering these figures and detailed explanations.

### BRIEF DESCRIPTION OF THE SEVERAL VIEWS OF THE DRAWINGS

FIG. 1 is a schematic view of the single-cell curtain fabric of the invention.

FIG. 2 is a schematic view of the double-cell curtain fabric of the invention.

FIG. 3 is a schematic view of the three-cell curtain fabric of the invention.

FIG. 4 is a schematic view of the four-cell curtain fabric of the invention.

FIG. 5 is a schematic view of the fabric pleating (crushing) machine, in which the curtain fabric of the invention is produced.

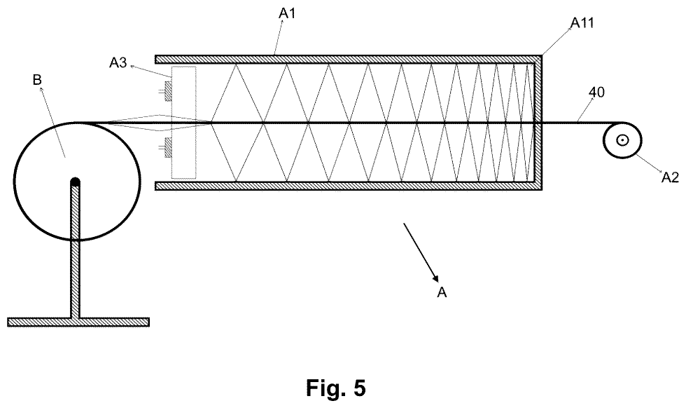

FIG. 6 is a schematic view of the special box, in which the curtain fabric of the invention is produced.

FIG. 7 is a schematic view of the pleating process, in which the curtain fabric of the invention is produced.

### REFERENCE NUMBERS

10. Upper fabric structure
20. Bottom fabric structure
30. Carrier guide thread path
40. Carrier guide thread
50. Connection zone
60. Pleat breaking point
A. Fabric crushing machine
A1. Special box
A11. Pleat fabric compression zone
A12. Openable special box cover
A13. Carrier guide thread hole
A2. Thread pulling system
A3. Press system
A4. Pushing system
B. Fabric ball ready for breaking
C. Pleated fabric

### DETAILED DESCRIPTION OF THE INVENTION

In this detailed description, preferred embodiments of the curtain fabric of the invention will be explained only for a better understanding of the subject matter and without any restrictive effect.

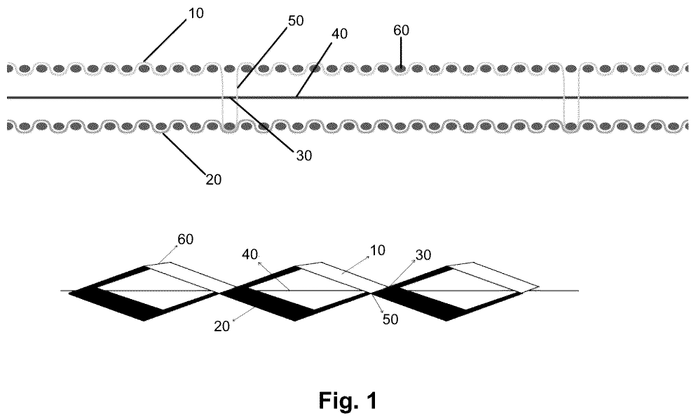

In FIG. 1, a schematic view of the single-cell curtain fabric of the invention. Accordingly, the fabric curtain is the most basic form comprises the upper fabric structure (10), which forms the floating half of the fabric structure created for air storage, the bottom fabric structure (20), which forms the other floating half of the fabric structure created for air storage, the carrier guide thread path (30) created at regular intervals on the upper fabric structure (10) and the bottom fabric structure (20), the carrier guide thread (40), which is passed through the carrier guide thread path (30), enabling the fabric to be collected more easily in the special box in the pleating process, the connection zone (50), which forms the intersection point of the upper fabric structure (10) and the bottom fabric structure (20) and forms the cells where the air will be stored within the upper fabric structure (10) and the bottom fabric structure (20), and the pleat breaking point (60), which forms the apex of the appropriate thread for the crushing process to take place in order to provide the honeycomb form to the cells where the air will be stored in the connection zones (50).

Woven structures are obtained by connecting warp and weft threads at an angle of 90 degrees relative to each other. The important parameters of woven fabrics are the number of warp and weft threads, the number of warp and weft per unit length, the fabric surface density, the folds of the warp and weft threads, and the weaving construction or knitting structure.

Woven mesh structures are collected in two groups. These are conventional (2-dimensional woven) and multi-layered (3-dimensional woven) structures. The classical weaving process is realized by the connection of two thread systems, warp and weft threads, with each other at an angle of 90 degrees. The warp threads are fed from a warp beam in the machine direction. The up and down movement of the warp threads is provided by a mechanism called the shedding opening mechanism. Depending on this mechanism, the warp threads can be opened in groups (dobby mechanism) or by selecting them one by one (jacquard mechanism). Which of the warp threads is lifted and which is not, determines the mesh of the weaving. The weft insertion mechanism moves the weft thread in a 90-degree direction with respect to the warp threads inside the opened shed, and deposits the weft thread between the warp threads. After the weft is inserted, the shed is closed again and thus the weft and warp threads are connected to each other. Then, the inserted weft is pushed by the reed towards the fabric line, that is, it is included in the fabric by being tampered with.

Layered woven fabrics are the structures formed by two groups of threads consisting of a series of weft threads and a series of warp threads, woven together, and two fabrics, one on top of the other, connected to each other during weaving. Different from 2-dimensional woven fabrics, a certain dimension is formed in the multi-layered (3-dimensional woven) fabric structures in the thickness direction or in the z direction. Fibers or threads connect with each other in the x, y and z directions. In other words, the desired form or shape is not provided later, but during weaving and by thread movements and connections in weaving.

The layered fabrics formed as a result of the bonding of the fabric layers between themselves without using any additional thread groups other than the basic warp and weft thread groups are called self-connected woven fabrics. If a warp thread belonging to the lower layer of the fabric forms a connection with the fabric on the upper floor and passes over the weft yarn of the upper floor, this structure is called “warp binding.” If a weft thread belonging to the lower layer of the fabric forms a connection with the fabric on the upper floor and passes over the warp yarn of the upper floor, this structure is called “weft binding.” In the structure of the curtain fabric of the invention, both binding forms are used in appropriate constructions.

The knits, consisting of two warp and two weft systems, in which the first warp and first weft system form the upper fabric structure of the fabric (10), and the second warp and second weft system form the bottom fabric structure (20) of the fabric, are called multi-layered fabric weaves. The structure of the curtain fabric of the invention is produced with the multi-layered fabric weaving technique. Here, the upper fabric structure (10) and the bottom fabric structure (20) intersect in a connection zone (50) after reaching the determined amount of floatation. With the connection zones (50), cells are formed in which air will be stored. The amount of air to be stored in the formed cells can be controlled by the number of wefts in the upper fabric structure (10) and the bottom fabric structure (20), thus increasing the variety of curtain fabrics. In order to give the honeycomb form to the cells where the air will be stored, it is necessary to create a pleat breaking point (60). Pleat breaking point (60) is the peak point where the appropriate yarn is used to make the breaking process easier. At the same time, in order to support the breaking process within the curtain fabric structure, which is the subject of the invention, carrier guide thread paths (30) placed at certain intervals were formed and carrier guide threads (40) were passed through said carrier guide thread paths (30).

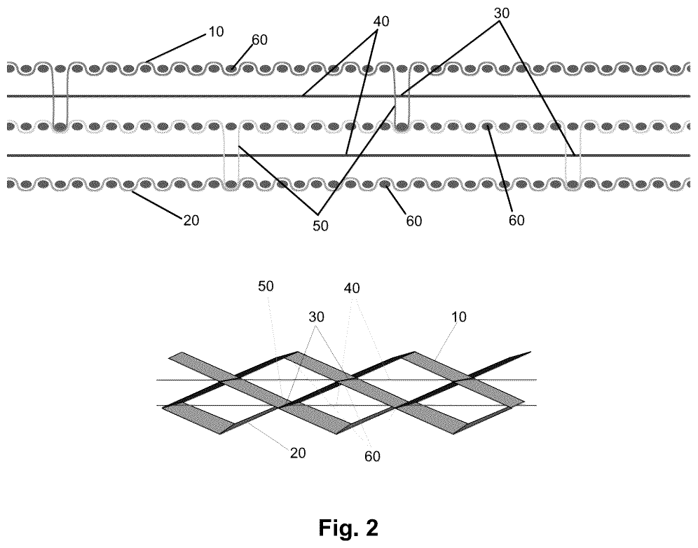

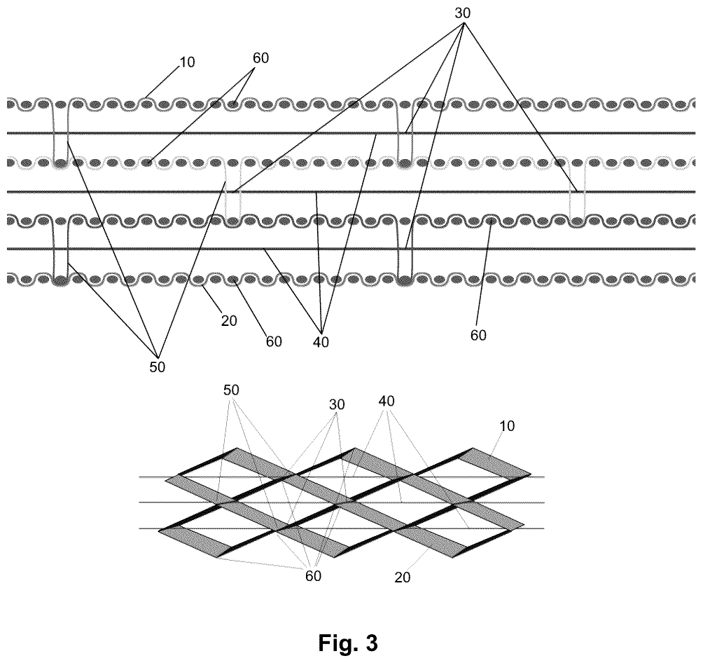

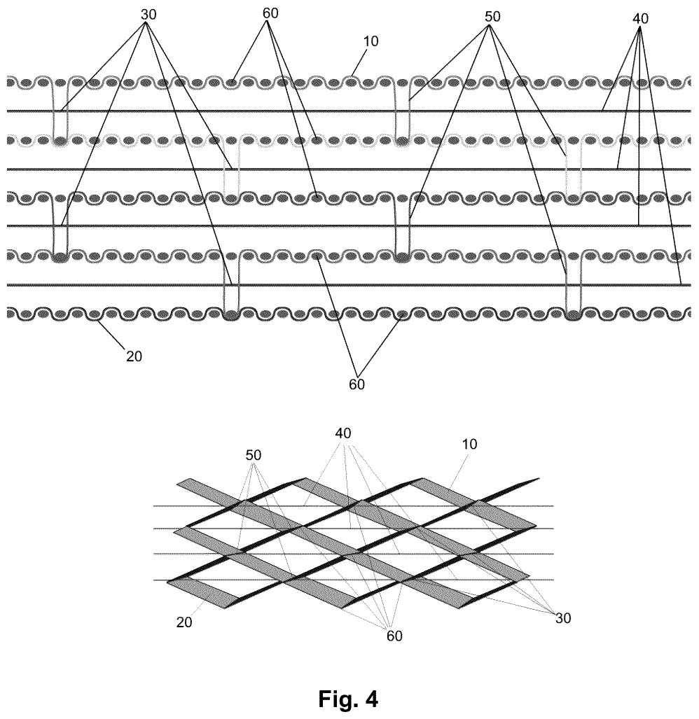

The curtain fabric subject to the invention may be single-celled as seen in FIG. 1, or it may be two-celled as seen in FIG. 2 in an alternative embodiment of the invention, or it may be three-celled as seen in FIG. 3 in another alternative embodiment of the invention, or it may be four-celled as seen in FIG. 4 in another alternative structure of the invention.

The curtain fabric of the invention is produced using the multi-layer woven fabric production technique and it is ensured that the fabric is turned into a semi-finished product by dyeing the processes suitable for the fabric whose weaving process has been completed.

The curtain fabric in the form of a fabric ball (B) ready for the breaking process, which is made a semi-finished product, is turned into a honeycomb curtain in the fabric crushing machine (A) where the breaking process will be applied. Fundamentally, the said fabric crushing machine (A) basically includes a special box (A1) in which the compression and breaking process of the pleated fabric is made, and a thread pulling system (A2) that provides the collection of the carrier guide threads (40) in the curtain fabric and ensures the compression of the fabric, and a press system (A3) that ensures that the pleated fabric is pressed in the special box (A1) after the breaking process and that the fabric stays in a certain mold and does not deteriorate with the pressure it makes at the same time.

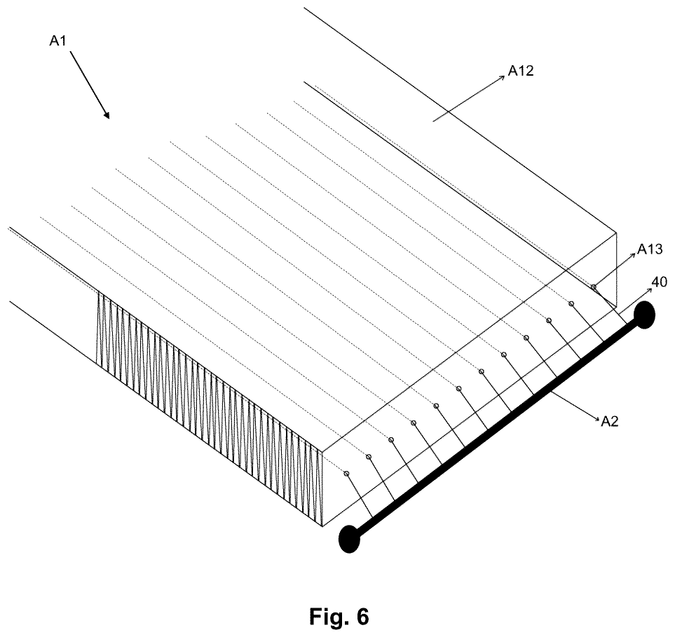

The special box (A1) where the compression and breaking process of the pleated fabric is carried out has an openable special box cover (A12) that allows the completed fabric to be removed from the profile as seen in FIG. 6, and the carrier guide thread holes (A13) that allow the carrier guide threads (40) in the curtain fabric to pass through the special box (A1).

The curtain fabric in the form of a fabric ball (B) ready for the breaking process, which has been turned into a semi-finished product, is fed horizontally into the special box (A1) in the fabric crushing machine (A) where the breaking process will be applied, and comes to the pleat fabric compression zone (A11) in the special box (A1) and the breaking process begins.

When the amount of fabric to be shipped is reached, the curtain fabric from the fabric ball (B) ready for breaking is separated and the dispersion of the curtain fabric is prevented by supporting the compression process with the press system (A3). By means of the thread pulling system (A2), it is ensured that the carrier guide threads (40) are pulled through the fabric structure.

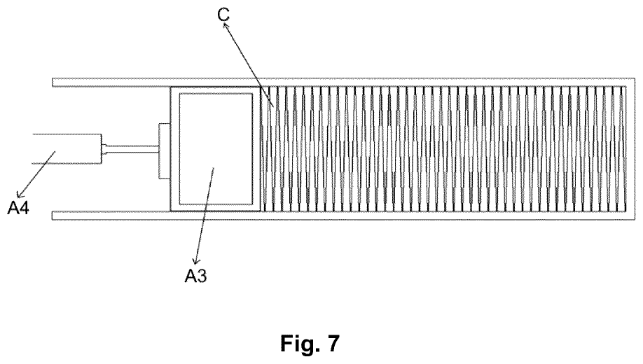

The partially compressed and pleated fabric (C) by the press system (A3) is completely compressed by means of a pushing system (A4) as shown in FIG. 7. In order to increase the permanence of the pile in the pleated fabric (C), the special box (A1) is placed in the fixing oven and processed at the appropriate temperature and time. In this way, the permanence of the thread in the given form is guaranteed at the applied temperature and the pleat breaking point (60). The curtain fabric, whose heat treatment has been completed, is taken by opening the special box (A1) cover and made ready for packaging.

We claim:

1. A blackout and semi-permeable, cellular curtain fabric used by connecting on all kinds of fixed, movable or folding windows, doors, glass balconies, the fabric comprising:
an upper fabric structure, which forms a floating half of the fabric structure created for air storage;
a bottom fabric structure, which forms an other floating half of the fabric structure created for air storage;
a carrier guide thread path created at regular intervals on the upper fabric structure and the bottom fabric structure;
a carrier guide thread, which is passed through the carrier guide thread path, enabling the fabric to be collected more easily in a special box in the pleating process;
a connection zone, which forms an intersection point of the upper fabric structure and the bottom fabric structure and forms the cells where the air will be stored within the upper fabric structure and the bottom fabric structure; and
a pleat breaking point, which forms an apex of the appropriate thread for the crushing process to take place in order to provide the honeycomb form to the cells where the air will be stored in the connection zones.

2. A production method of a blackout and semi-permeable, cellular curtain fabric according to claim 1, the method comprising the process steps of:
feeding the curtain fabric in the form of a fabric ball ready for pleating process, which is produced by using multi-layered woven fabric production technique and turned into semi-finished products, horizontally into the special box in the fabric crushing machine where breaking process will be applied, and initiating the breaking process by coming to the pleat fabric compression zone in the special box;
when the amount of fabric to be shipped is reached, separating the curtain fabric from the fabric ball ready for breaking and preventing the dispersion of the curtain fabric by supporting the compression process with the press system;
pulling the carrier guide threads through the fabric structure by means of the thread pulling system in the fabric crushing machine;
fully compressing the partially compressed and pleated fabric with the press system by means of a pushing system;
placing the special box in the fixing oven and processing it at the appropriate temperature and time to increase the permanence of the pleat in the pleated fabric; and
preparing the curtain fabric, the heat treatment of which has been completed, from the special box and ready for packaging.
